(19) United States
(12) Patent Application Publication
(10) Pub. No.: US 2017/0161353 A1
(43) Pub. Date: Jun. 8, 2017

(54) SYSTEM, METHOD AND DEVICE FOR OPTIMIZING DATABASE OPERATIONS

(71) Applicant: Alibaba Group Holding Limited, Grand Cayman (KY)

(72) Inventor: Yu JIANG, Hangzhou (CN)

(21) Appl. No.: 15/367,259

(22) Filed: Dec. 2, 2016

(30) Foreign Application Priority Data
Dec. 8, 2015 (CN) 201510897535.8

(51) Int. Cl. G06F 17/30

(52) U.S. Cl. CPC G06F 17/30592; G06F 17/30899; G06F 17/30548

(57) ABSTRACT

A system, method, and apparatus for optimizing database transactions in a multi-version concurrency control system are disclosed. The method includes receiving a pending transaction; acquiring predictive execution data associated with the pending transaction, wherein the predictive execution data includes a primary key value of target data required by the pending transaction and a value of the target data in the predictive execution; retrieving a current value of the target data from a target secondary database based on the primary key value of the target data; determining whether the current value of the target data affects service logic of the pending transaction based on whether the current value of the target data is different from the value of the target data; and recording in the target secondary database, the current value of the target data as version data corresponding to the pending transaction upon determining that the current value of the target data does not affect the service logic of the pending transaction.

### CROSS-REFERENCE TO RELATED APPLICATIONS

This application claims the benefit of priority from Chinese Patent Application No. 201510897535.8, filed on Dec. 8, 2015, entitled “Method and Apparatus for Operating Database,” which is incorporated herein by reference in its entirety.

### BACKGROUND

Field of the Disclosure

The disclosure relates to the field of database technologies, and in particular to systems, methods, and devices for optimizing database transactions.

Description of Related Art

A stand-alone database can conveniently meet the demands of a user for relational queries and is currently the most commonly used type of database. However, for many applications, stand-alone databases eventually suffer from performance bottlenecks relating to transactions per second, queries per second, memory capacity, disk capacity, and the like. Distributed database systems represent one attempt to remedy such bottlenecks. With distributed database systems, data originally stored in stand-alone databases is stored in a distributed manner in multiple data storage nodes that are connected through a network. Thus, distributed databases inherently provide greater storage capacity and greater concurrency.

In a distributed database system, one secondary database may need to acquire data from other secondary databases when a transaction involving multiple secondary databases is executed. Because the secondary databases run asynchronously at different speeds, when a slow-running secondary database acquires required data from a fast-running secondary database, a multi-version concurrency control (MVCC) mechanism may be used to allow the slow-running secondary database to acquire the required data from the fast-running secondary database. For each batch of transactions involving the same data, data of corresponding versions is recorded in the secondary databases using the MVCC mechanism. By using an MVCC mechanism, the slow-running secondary database can read the data of the corresponding version from the fast-running secondary database.

However, MVCC mechanisms cause a significant increase in the storage overhead of the database. For example, if the processing speed of a distributed database system is 100 batches of transactions per second, and if a certain secondary database is delayed by 10 minutes due to a fault, other secondary databases need to store 10×60×100=60,000 data versions, consuming a large amount of disk capacity of the secondary databases.

### BRIEF SUMMARY

To solve the above technical problems, the described embodiments of the disclosure provide methods, devices, and systems for reducing storage overhead of an MVCC and for reducing disk capacity required by a database.

In one embodiment, the disclosure describes a method for optimizing database transactions. The method includes receiving a pending transaction; acquiring predictive execution data associated with the pending transaction, wherein the predictive execution data includes a primary key value of target data required by the pending transaction and a value of the target data in the predictive execution; retrieving a current value of the target data from a target secondary database based on the primary key value of the target data; determining whether the current value of the target data affects service logic of the pending transaction based on whether the current value of the target data is different from the value of the target data; and recording in the target secondary database, the current value of the target data as version data corresponding to the pending transaction upon determining that the current value of the target data does not affect the service logic of the pending transaction.

In another embodiment, the disclosure describes an apparatus for optimizing database transactions. The apparatus includes a processor and a non-transitory memory storing computer-executable instructions. When executed by the processor, the instructions cause the apparatus to receive a pending transaction; acquire predictive execution data associated with the pending transaction, wherein the predictive execution data includes a primary key value of target data required by the pending transaction and a value of the target data in the predictive execution; retrieve a current value of the target data from a target secondary database based on the primary key value of the target data; determine whether the current value of the target data affects service logic of the pending transaction based on whether the current value of the target data is different from the value of the target data; and record in the target secondary database, the current value of the target data as version data corresponding to the pending transaction upon determining that the current value of the target data does not affect the service logic of the pending transaction.

In another embodiment, the disclosure describes a system for optimizing database transactions. The system includes an application server and one or more database servers. The system further includes a database operation device configured to receive a pending transaction. The database operation device may include an acquiring module configured to acquire predictive execution data associated with the pending transaction, wherein the predictive execution data includes a primary key value of target data required by the pending transaction and a value of the target data in the predictive execution. The database operation device may include a loading module configured to retrieve a current value of the target data from a target secondary database based on the primary key value of the target data. The database operation device may include a determining module configured to determine whether the current value of the target data affects service logic of the pending transaction based on whether the current value of the target data is different from the value of the target data. The database operation device may include a version data processing module configured to record in the target secondary database, the current value of the target data as version data corresponding to the pending transaction upon determining that the current value of the target data does not affect the service logic of the pending transaction.

In the disclosure, a predictive execution is performed in advance on a pending transaction, so as to obtain in advance a primary key value of target data required by the pending transaction and a value of the target data in the predictive execution; in the actual execution process of the pending transaction, the value of the target data in the predictive execution is compared with a current value of the target data; and the current value of the target data is recorded, in a secondary database, as version data corresponding to the pending service logic of the pending transaction. In the disclosure, in one aspect, the objective of recording multi-version data is achieved, which helps solve the problem that secondary databases cannot read data of corresponding versions when reading data from each other in a distributed database system, and in another aspect, version data is recorded only when data has conflicts and a pending transaction needs to be executed normally, which helps reduce the amount of recorded data, reduce storage overheads, and reduce disk capacity required by a database.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views.

FIG. 1 is a diagram of a database application system in the prior art.

FIG. 2 is a diagram of a database application system, according to some embodiments of the disclosure.

FIG. 3 is a flow diagram illustrated a method for performing a database operation, according to some embodiments of the disclosure.

FIG. 4 is a diagram of a database operation device, according to some embodiments of the disclosure.

FIG. 5 is a diagram of a database operation device, according to some embodiments of the disclosure.

### DETAILED DESCRIPTION

The embodiments of the disclosure provide methods, devices and systems for reducing storage overhead of an MVCC and for reducing disk capacity required by a database. For better understanding of the technical solutions of the disclosure by those skilled in the art, the technical solutions of the embodiments of the disclosure will be described clearly and completely in combination with the drawings herein. It is clear that the described embodiments are only some, not all, of the possible embodiments of the disclosure. Any other embodiments obtained by those skilled in the art based on the embodiments of the disclosure are intended to fall within the protection scope of the disclosure. The detailed implementations of the embodiments of the disclosure are described with the following specific examples. Although the methods described below contain multiple operations in a certain sequence, it should be understood that these methods may contain more or less operations that can be executed in sequence or concurrently (e.g., using parallel processors or in a multi-threaded environment).

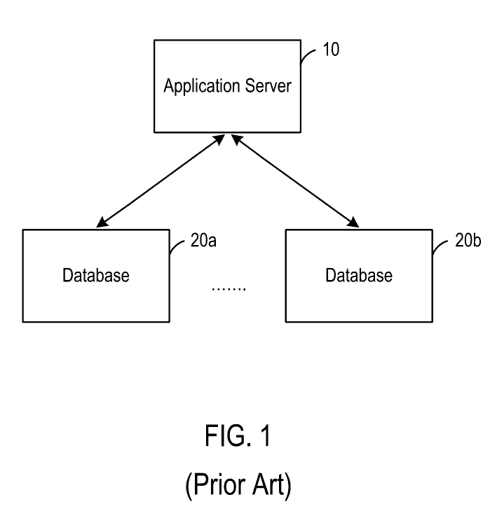

FIG. 1 is a diagram of a database application system in the prior art.

As shown in FIG. 1, the system 100 includes an application server 10 and at least two databases 20a and 20b. The two databases 20a and 20b constitute a distributed database system, and one of database 20a or 20b serves as a secondary database in the distributed database system.

A secondary database may acquire data from other secondary databases when a transaction involving multiple secondary databases runs in a distributed database system (e.g., when data from a remote secondary database is required to execute a transaction on a local secondary database). Because secondary databases may run asynchronously and at different speeds in the distributed database system, when a slow-running secondary database acquires required data from a fast-running secondary database, an MVCC mechanism is generally used in order to ensure that the slow-running secondary database can acquire the required data from the fast-running secondary database. That is, for each batch of transactions involving the same data, data of corresponding versions is recorded in the secondary databases according to the MVCC mechanism, so that the slow-running secondary database can read the data of the corresponding version from the fast-running secondary database.

However, MVCC mechanisms result in an increase in the storage overhead incurred by the database and increased disk capacity of the secondary databases due to the storage requirements of the recorded multi-version data.

In view of the deficiencies of existing distributed databases, the disclosure describes methods, devices, and systems that predictively execute pending transactions in advance, in order to obtain a primary key value of target data required by the pending transaction and a value of the target data in the predictive execution. When the pending transaction is actually executed, the value of the target data in the predictive execution is compared with a current value of the target data and the current value of the target data is recorded, in a secondary database, as version data corresponding to the pending transaction only when the target data has conflicts but the current value of the target data does not affect a service logic of the pending transaction. Recording the corresponding version data in the secondary database for the pending transaction is prohibited in other situations. In this way, the recording of multi-version data is achieved, which helps solve the problem that secondary databases cannot read data of corresponding versions when reading data from each other in a distributed database system. Further, version data is recorded only when data has conflicts and does not affect the service logic of a pending transaction, which reduces the amount of recorded version data, reduces storage overheads, and helps reduce disk capacity required by a database.

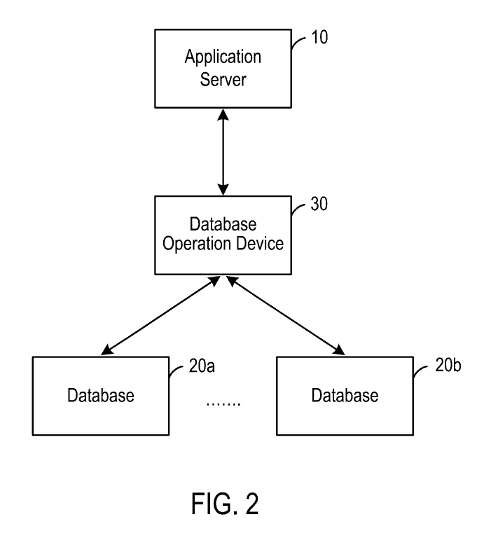

FIG. 2 is a diagram of a database application system, according to some embodiments of the disclosure. The system illustrated in FIG. 2 remedies the aforementioned deficiencies of existing database application systems as described more fully herein.

In the embodiment illustrated in FIG. 2, a database operation device 30 is added between an application server 10 and at least two databases 20a and 20b in the system. The database operation device 30 performs a predictive execution, in advance, upon receiving a pending transaction from, for example, application server 20. The database operation device 30 may, in advance, further obtain database operation instructions that actually need to be executed in the pending transaction to predict an execution path of a transaction. The database operation device 30 may, in advance, further obtain predictive execution data, such as a primary key value of the target data required by the pending transaction and a value of the target data in the predictive execution.

In addition, the database operation device 30 in the system is also able to control the databases 20a and 20b to actually execute the pending transaction according to the database operation instructions and the predictive execution data obtained through the predictive execution. In the prior art system shown in FIG. 1, when a database 20a or 20b needs to be accessed transactionally, the application server 10 executes transaction logic and sequentially performs database operation instructions in a transaction at the database 20a or 20b. Such a transaction execution mode is inefficient and results in low transactional throughput. Compared with the system shown in FIG. 1, the system illustrated in FIG. 2 improves transaction execution efficiency and increases transaction throughput, transaction throughput referring to the number of transactions processed per unit of time.

In one embodiment, the database operation device 30 may be implemented as a separate logic processing device that is deployed independently and is located between the application server 10 and the databases 20a and 20b. Alternatively, the database operation device 30 may be implemented as part of the server 10 or as part of a database 20a or 20b.

One embodiment of a method performed by the database operation device 30 performs a predictive execution on the pending transaction is specifically as follows.

The database operation device 30 sequentially acquires database operation instructions in the pending transaction that are executed by the application server 10 when the application server 10 executes the pending transaction. The database operation device 30 then performs a predictive execution on the database operation instructions and returns predictive execution results to the server 10 so that the application server 10 may determine a next database operation instruction that needs to be executed. The database operation device 30 then and records locally the database operation instructions and predictive execution data generated through the predictive execution.

It should be noted that the pending transaction in the previous embodiment primarily includes database operation instructions but may also include control instructions for controlling a target transaction execution state. Control instructions may include a BEGIN TRANSACTION instruction, a COMMIT TRANSACTION instruction, or a ROLLBACK TRANSACTION instruction. These instructions may be statements written in a database query language such as SQL. Furthermore, these instructions may be statements written by using different statements according to different database query languages. For example, if SQL is used, the database operation instructions and the control instructions may comprise a series of SQL statements.

In the foregoing embodiment, the application server 10 controls the execution logic of the entire pending transaction and can execute the pending transaction in the manner disclosed above. The database operation device 30 sequentially acquires database operation instructions in the pending transaction that are executed by the application server 10 when the application server 10 executes the pending transaction.

In an alternative embodiment, the application server 10 may send database operation instructions to a target secondary database corresponding to the pending transaction, thus accessing the target secondary database. The database operation device 30 may monitor communication between the application server 10 and the target secondary database to intercept the database operation instructions sent by the application server 10 to the target secondary database. For ease of description and differentiation, the secondary database corresponding to the pending transaction involved in this embodiment is referred to as a “target secondary database” and the target secondary database is one database in a distributed database system including multiple databases.

In an alternative embodiment, the application server 10 may send the database operation instructions to the database operation device 30 instead of to the target secondary database corresponding to the pending transaction to. Based on this, the database operation device 30 may receive the database operation instructions actively delivered by the application server 10.

It should be noted here that if the pending transaction is an explicit transaction (e.g., a transaction wherein the first instruction in the pending transaction comprises a BEGIN TRANSACTION instruction), before acquiring database operation instructions executed by the application server, the database operation device may intercept the BEGIN TRANSACTION instruction in the pending transaction that is sent by the application server to the target secondary database, and identify that the pending transaction needs to be executed according to the BEGIN TRANSACTION instruction. Alternatively, before acquiring database operation instructions executed by the application server, the database operation device may receive the BEGIN TRANSACTION instruction in the pending transaction that is actively delivered by the application server, and learn that the pending transaction needs to be executed according to the BEGIN TRANSACTION instruction. If the pending transaction is an implicit transaction, the first instruction of the pending transaction is a database operation instruction, and the step of acquiring the BEGIN TRANSACTION instruction is not included.

After acquiring the database operation instructions executed by the application server 10, the database operation device 30 performs predictive execution on the acquired database operation instructions, and returns predictive execution results to the application server 10 so that the application server 10 can determine a next database operation instruction that needs to be executed. The predictive execution results determine an execution path of the pending transaction, and the execution path herein refers to the jump logic of database operation instructions. The predictive execution results are returned to the application server 10, so as to achieve the objective of controlling the execution logic of the entire pending transaction by the application server 10.

In addition, the database operation device 30 further needs to record locally acquired database operation instructions and record predictive execution data generated by performing a predictive execution on the database operation instructions. The predictive execution data mainly refers to data in the predictive execution process performed on the database operation instructions, for example, a primary key of target data required by the pending transaction and a value of the target data in the predictive execution. For example, the database operation device 30 may create an in-memory database locally and store the database operation instructions and the predictive execution data that are acquired in the in-memory database.

In this embodiment, the main purpose of the database operation instruction is to access data in the target secondary database, and then a data environment of the database operation instruction may be simulated, and predictive execution is performed on the database operation instruction based on the simulated data environment. Based on this, a manner of performing a predictive execution on the database operation instruction may include simulating a data environment required by the database operation instruction in the locally created memory database and performing a predictive execution on the database operation instruction based on the simulated data environment.

Further, an embodiment of simulating a data environment of the database operation instruction in the locally created in-memory database and performing a predictive execution on the database operation instruction based on the simulated data environment may include the following operations.

First, the database operation device 30 may split the acquired database operation instruction into a read instruction and a write instruction, making the read instruction run on a real target secondary database. That is, executing the read instruction in the target secondary database to acquire a read data set (ReadSet) and storing the read data set in the local in-memory database, so as to simulate the data environment required by the database operation instruction. Then, the database operation device 30 may execute the write instruction on the in-memory database to realize predictive execution on the database operation instruction. That is, executing the write instruction in the in-memory database to modify the read data set. For example, performing an update or query processing on relevant data in the read data set, wherein a result data set (affectRowInMemdb) may be generated by executing the write instruction to modify the read data set, and the result data set includes a predictive execution result.

In the foregoing predictive execution process, the database operation device 30 may record locally the read data set read by the read instruction and execute the result data set generated by the write instruction. The predictive execution data may include the read data set and the result data set, or include some data in the read data set and the result data set, for example, some data capable of producing beneficial effects on actual execution of the pending transaction in a database, for example, a primary key value of target data required by the pending transaction and a value of the target data in the predictive execution.

The database operation device 30 respectively performs the prediction operation on sequentially acquired database operation instructions to obtain the database operation instructions and corresponding predictive execution data thereof, and stores them in the memory database.

Based on the obtained predictive execution data of the pending transaction, the pending transaction may be actually executed according to the methods described below.

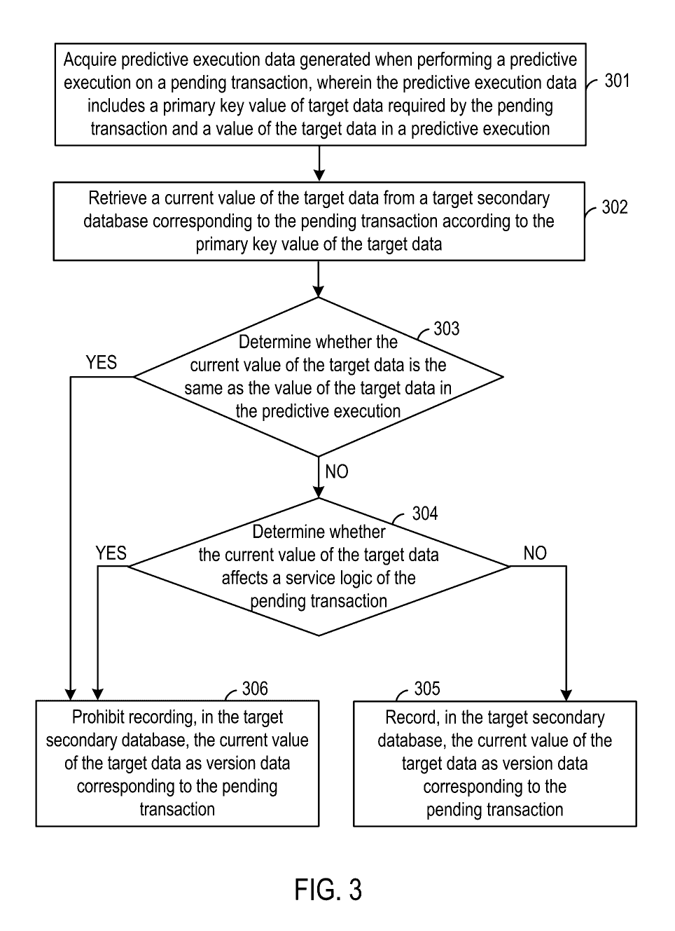

FIG. 3 is a flow diagram illustrating a method for performing a database operation, according to some embodiments of the disclosure.

In step 301, the method acquires predictive execution data generated by predictively executing a pending transaction. In some embodiments, the predictive execution data includes a primary key value of target data required by the pending transaction and a value of the target data in the predictive execution.

In step 302, the method retrieves a current value of the target data from a target secondary database corresponding to the pending transaction according to the primary key value of the target data.

In step 303, the method determines whether the current value of the target data is the same as the value of the target data generated by the predictive execution. If the result of the determination is negative (i.e., the current value of the target data is different from the value of the target data in the predictive execution), the method performs step 304. If the result of the determination is positive, the method performs step 306.

In step 304, the method determines whether the current value of the target data affects the service logic of the pending transaction. If the result of this determination is negative (i.e., the current value of the target data does not affect the service logic of the pending transaction), the method performs step 305. If the result of the determination is positive, the method performs step 306.

In step 305, the method records, in the target secondary database, the current value of the target data as the version data corresponding to the pending transaction.

In step 306, the method prohibits recording, in the target secondary database, the current value of the target data as the version data corresponding to the pending transaction.

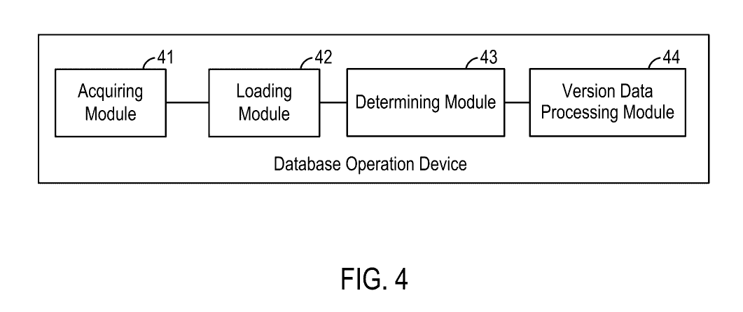

The method illustrated in FIG. 3 may be performed by a database operation device, such as the device illustrated in FIG. 4. The database operation device may comprise a processing device that may be deployed separately and located between the application server 10 and the databases 20a and 20b. Alternatively, the database operation device may be co-located with databases 20a and 20b, for example, as an execution process on the databases 20a and 20b.

In another embodiment, the database operation device and the predictive database execution device in this embodiment may be implemented as two separate devices and deployed separately. In this embodiment, the predictive execution process performed on pending transactions may be implemented by the predictive database execution device. Alternatively, the database operation device and the predictive database execution device may be implemented as one device (for example, the database operation device), which means that the predictive execution process performed on pending transactions may be implemented by the database operation device.

In an alternative embodiment, upon detecting, for example, a COMMIT TRANSACTION instruction in a pending transaction, the predictive database execution device may further control a target secondary database corresponding to the application server to actually execute the pending transaction according to the database operation instructions and the predictive execution data that are recorded locally. It should be noted that the predictive database execution device may deliver the predictive execution data and the database operation instructions to the database operation device to instruct the database operation device to actually execute the pending transaction on the target secondary database. The database operation device may receive the predictive execution data delivered by the predictive database execution device. In addition, the database operation device further receives the database operation instructions delivered by the predictive database execution device and actually executes the pending transaction on the target secondary database according to the predictive execution data and the database operation instructions that are received.

After acquiring the predictive execution data, the database operation device may load, according to a primary key value of data required by the pending transaction in the predictive execution data, a current value of the target data from a target secondary database corresponding to the pending transaction. The database operation device may then compare the loaded current value of the target data with a value of the target data in the predictive execution data in the predictive execution and determine whether the current value of the target data is the same as the value of the target data in the predictive execution.

If the comparison result is that the current value of the target data is different from the value of the target data in the predictive execution, it indicates that the data has conflicts, and then it is further determined whether the current value of the target data affects the service logic of the pending transaction. That is, whether the pending transaction can be executed successfully according to the current value of the target data.

If the determining result is that the current value of the target data does not affect the service logic of the pending transaction, it indicates that the data has conflicts, but does not affect normal execution of the pending transaction, and the pending transaction may be executed normally in order to reduce transaction rollback probability. However, due to the inconsistency of the target data, the problem that target data of a corresponding version cannot be acquired when other secondary databases acquire target data from the target secondary database may arise. Accordingly, corresponding version data needs to be stored for the pending transaction in this embodiment, and then the current value of the target data is recorded, in the target secondary database, as version data corresponding to the pending transaction, the pending transaction is executed according to the current value of the target data, and the current value of the target data in the target secondary database is updated according an execution result of the pending transaction.

Further, if it is determined that the current value of the target data affects the service logic of the pending transaction, it indicates that the data has conflicts and also affects the service logic of the pending transaction, and then the pending transaction needs to be rolled back. Because the pending transaction needs to be rolled back, other secondary databases also need to perform rollback upon executing the pending transaction, and thus it makes no sense to obtain version data corresponding to the pending transaction, and it obviously makes no sense to record, in the target secondary database, the version data corresponding to the pending transaction. Therefore, upon determining that the data has conflicts and the current value of the data affects the service logic of the pending service, the database operation device prohibits recording, in the target secondary database, the current value of the target data as the version data corresponding to the pending transaction, which reduces storage overheads and helps reduce disk capacity required by the target secondary database. In addition, the database operation device further needs to roll back the pending transaction. Furthermore, because the version data corresponding to the pending transaction does not need to be written into the target secondary database, and a corresponding deletion operation does not need to be performed because it is not written, operations of interaction with the target secondary database are reduced, which helps increase the processing speed of the pending transaction.

Further, if it is determined that the current value of the target data is the same as the value of the target data used in the predictive execution in the determining process, because the data has been recorded or stored in the predictive execution, the pending transaction may be restored by using the data recorded in the predictive execution when the pending transaction has errors, so that the data does not need to be recorded again in the target secondary database. Therefore, upon determining that the current value of the target data is the same as the value of the target data used in the predictive execution, the database operation device prohibits recording, in the target secondary database, the current value of the target data as the version data corresponding to the pending transaction, which reduces storage overheads and helps reduce disk capacity required by the target secondary database. In addition, the database operation device further needs to execute the pending transaction according to the current value of the target data, and update the current value of the target data in the target secondary database according to an execution result of the pending transaction. Furthermore, because only the current value of the target data in the target secondary database needs to be updated and the version data corresponding to the pending transaction does not need to be written into the target secondary database, and a corresponding deletion operation does not need to be performed because it is not written, operations of interaction with the target secondary database are reduced, which helps increase the processing speed of the pending transaction.

In the situation that the pending transaction needs to be executed according to the current value of the target data, the database operation device may further acquire database operation instructions determined when performing the predictive execution on the pending transaction, wherein the database operation instructions actually need to be executed in the pending transaction. For example, the database operation device may receive the database operation instructions that actually need to be executed in the pending transaction and are delivered by the predictive database execution device. The database operation device specifically processes the current value of the target data according to the database operation instructions that actually need to be executed in the pending transaction, so as to obtain the execution result of the pending transaction. Herein, the manner of processing the current value of the target data depends on the service logic of the pending transaction. For example, the current value of the target data may be increased by 50, 30, 100 or the like in the case of debiting; for another example, the current value of the target data may be decreased by 1, 2, 10 or the like in the case of inventory reduction, and so on.

Using an inventory reduction transaction as an example of a pending transaction an inventory read during the predictive execution process of the inventory reduction transaction may be 10, while a current value of the inventory read in the actual execution process of the inventory reduction transaction is 10. Because the inventory does not change and has been recorded or stored in the predictive execution process, the inventory of a corresponding version may not be recorded again for the inventory reduction transaction in the actual execution process of the inventory reduction transaction, so that storage overheads are reduced, operations of interaction with the target secondary database are reduced, and the transaction processing speed is increased.

Continuing the previous example, an inventory read in the predictive execution process of the inventory reduction transaction may be 10, while a current value of the inventory read in the actual execution process of the inventory reduction transaction is 8. The current value (8) of the inventory is different from the value read in the predictive execution (10), and then it is further determined whether the current value of the inventory affects a service logic of the pending transaction. In one example, the pending transaction may represent the purchase of one item of merchandise and the service logic thereof includes operations reducing the inventory by 1 when the inventory is greater than or equal to 1. Because the current value of the inventory is 8, not affecting the service logic of the pending transaction, the inventory may be changed to 7 by subtracting 1 from 8 and meanwhile the inventory that is 8 is recorded, in the target secondary database, as version data of the inventory reduction transaction. In a second example, the pending transaction may include operations representing the purchase of ten (10) items of merchandise, and the service logic thereof includes operations of reducing the inventory by 10 when the inventory is greater than or equal to 10. Then, because the current value of the inventory is 8, the current value affects the service logic of the inventory reduction transaction, which means that the inventory reduction transaction cannot be executed successfully and the inventory reduction transaction needs to be rolled back, version data corresponding to the inventory reduction transaction does not need to be recorded in the target secondary database, which helps reduce storage overheads and reduce disk capacity required by the target secondary database. In addition, because the inventory corresponding to the inventory reduction transaction does not need to be written into the target secondary database, and a corresponding deletion operation does not need to be performed because it is not written, operations of interaction with the target secondary database are reduced, which helps increase the processing speed of the inventory reduction transaction.

In view of the above, the predictive database execution device and the application server cooperate with each other. In one embodiment, a predictive execution process is added in the process when the application server executes a pending transaction. All database operation instructions that need to be executed in the pending transaction and predictive execution data are obtained in advance and recorded, so as to provide a condition for real execution of the transaction. Then, relevant data can be acquired in advance and jumps between instructions can be reduced when the pending transaction is actually executed according to the database operation instructions and the predictive execution data that are recorded, which helps improve execution efficiency and increase transaction throughput.

In addition, in the process that the database operation device actually executes the pending transaction, whether data has conflicts and whether the data affects the service logic of the pending transaction are determined based on the predictive execution data generated in the predictive execution process, and then version data is recorded only when the data has conflicts and the pending transaction needs to be executed normally, which helps reduce the amount of recorded data, reduce storage overheads, and reduce disk capacity required by a database.

It should be noted that the foregoing method embodiments, for simple description, are described as a combination of a series of actions. However, those skilled in the art should know that the disclosure is not limited by the sequence of the actions described, because some steps may be performed in other sequences or concurrently according to the disclosure. In addition, those skilled in the art should also learn that the embodiments described in the specification are preferred embodiments, and the actions and modules involved may not be necessary for the disclosure.

In the foregoing embodiments, the descriptions of the embodiments place different emphasis on different aspects, and for a part that is not detailed in an embodiment, reference can be made to the relevant descriptions of other embodiments.

FIG. 4 is a diagram of a database operation device, according to some embodiments of the disclosure. As shown in FIG. 4, the device includes: an acquiring module 41, a loading module 42, a determining module 43, and a version data processing module 44.

The acquiring module 41 is configured to acquire predictive execution data generated when performing a predictive execution on a pending transaction. As discussed above, the predictive execution data may include a primary key value of target data required by the pending transaction and a value of the target data in the predictive execution.

The loading module 42 is configured to load a current value of the target data from a target secondary database corresponding to the pending transaction according to the primary key value of the target data that is acquired by the acquiring module 41.

The determining module 43 is configured to, when the current value of the target data that is loaded by the loading module 42 is different from the value of the target data in the predictive execution that is acquired by the acquiring module 41, determine whether the current value of the target data affects the service logic of the pending transaction.

The version data processing module 44 is configured to, when the determining module 43 determines that the current value of the target data does not affect the service logic of the pending transaction, record, in the target secondary database, the current value of the target data as the version data corresponding to the pending transaction.

In an alternative embodiment, the version data processing module 44 is further configured to prohibit recording, in the target secondary database, the current value of the target data as the version data corresponding to the pending transaction, when the current value of the target data is the same as the value of the target data in the predictive execution.

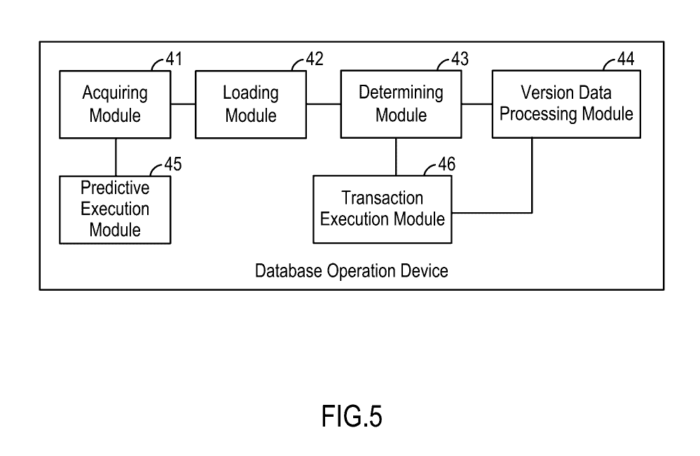

FIG. 5 is a diagram of a database operation device, according to some embodiments of the disclosure. As shown in FIG. 5, the device includes: an acquiring module 41, a loading module 42, a determining module 43, a version data processing module 44, a predictive execution module 45, and a transaction execution module 46.

The transaction execution module 56 is configured to, when the determining module 43 determines that the current value of the target data does not affect the service logic of the pending transaction or when the current value of the target data is the same as the value of the target data in the predictive execution, execute the pending transaction according to the current value of the target data, and update the current value of the target data in the target secondary database according to an execution result of the pending transaction.

Optionally, the acquiring module 41 may also be configured to acquire database operation instructions determined when performing the predictive execution on the pending transaction, wherein the database operation instructions include instructions that are required to be executed in the pending transaction. For example, in the situation that the predictive execution process on the pending transaction is implemented by another device different from the database operation device, the acquiring module 41 may be specifically configured to receive the predictive execution data and the database operation instructions that need to actually be executed in the pending transaction, wherein the predictive execution data and the database operation instructions are delivered by the device that performs the predictive execution on the pending transaction.

Based on the above, the transaction execution module 46 may be specifically configured to process the current value of the target data according to the database operation instructions that need to actually be executed in the pending transaction, so as to obtain the execution result of the pending transaction.

In an alternative embodiment, the version data processing module 44 is further configured to prohibit recording, in the target secondary database, the current value of the target data as the version data corresponding to the pending transaction, and roll back the pending transaction if the determining module 43 determines that the current value of the target data affects the service logic of the pending transaction.

In an alternative embodiment, the database operation device further includes a predictive execution module 45 configured to perform a predictive execution on the pending transaction to generate the predictive execution data.

The predictive execution module 45 may be configured to sequentially acquire database operation instructions in the pending transaction that are executed by an application server in the process that the application server executes the pending transaction. The predictive execution module 45 may then perform a predictive execution on the acquired database operation instructions and return predictive execution results to the application server so that the application server determines a next database operation instruction that needs to be executed. The predictive execution module 45 may then record locally the database operation instructions and predictive execution data generated through predictive execution.

In the process of actually executing a pending transaction, the database operation device may determine whether the data has conflicts and whether the data affects the service logic of a pending transaction based on predictive execution data generated in the predictive execution process. The database operation device may then record version data only when the data has conflicts and the pending transaction needs to be executed normally, which reduces the amount of recorded data, storage overheads, and disk capacity required by a database.

Those skilled in the art may clearly understand that, for the purpose of convenient and brief description, the detailed working process of the described system, device, and unit, may make reference to the corresponding process in the foregoing method embodiments, therefore details will not repeated herein.

In the several embodiments provided in the disclosure, it should be understood that the disclosed system, device, and method may be implemented in other manners. For example, the described device embodiments are merely exemplary. For example, the unit division is merely logical function division, but may be other manners of division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the devices or units may be implemented in electrical, mechanical, or other forms.

The units described as separate parts may be or may not be physically separated. The parts displayed as units may be or may not be physical units, that is, they may be located at one place or distributed on a plurality of network units. Some or all of the units may be selected to achieve the objective of the solution of the embodiment according to actual demands.

In addition, functional units in the embodiments of the disclosure may be integrated into one processing unit or each of the units may exist alone physically, or two or more units may be integrated into one unit. The integrated unit may be implemented in the form of hardware or implemented in the form of hardware plus a software functional unit.

The integrated unit implemented in the form of a software functional unit may be stored in a computer readable storage medium. The software functional unit is stored in a storage medium and includes several instructions for instructing a computer device (which may be a personal computer, a server, a network device, or the like) or a processor to perform some of the steps of the methods described in the embodiments of the disclosure. The storage medium includes any medium that is capable of storing program codes, such as a USB flash drive, a removable hard drive, a read-only memory (ROM), a random access memory (RAM), a magnetic disk, an optical disc or the like.

Finally, it should be noted that the foregoing embodiments are merely provided for describing the technical solutions of the disclosure, and are not intended to limit the disclosure. It should be understood by those of ordinary skill in the art that although the disclosure has been described in detail with reference to the foregoing embodiments, modifications can be made to the technical solutions described in the foregoing embodiments, or equivalent replacements can be made to some technical features in the technical solutions, so long as such modifications or replacements do not cause the essence of corresponding technical solutions to depart from the spirit and scope of the technical solutions in the embodiments of the disclosure.

What is claimed is:

1. A method for optimizing database transactions, the method comprising:
receiving, by a server, a pending transaction;
acquiring, by the server, predictive execution data associated with the pending transaction, wherein the predictive execution data includes a primary key value of target data required by the pending transaction and a value of the target data;
retrieving, by the server, a current value of the target data from a target secondary database based on the primary key value of the target data;
determining, by the server, whether the current value of the target data affects service logic of the pending transaction based on whether the current value of the target data is different from the value of the target data; and
recording, by the server, in the target secondary database, the current value of the target data as version data corresponding to the pending transaction upon determining that the current value of the target data does not affect the service logic of the pending transaction.

2. The method of claim 1, further comprising:
prohibiting, by the server, the recording of the current value of the target data as version data corresponding to the pending transaction in the target secondary database upon determining that the current value of the target data affects the service logic of the pending transaction.

3. The method of claim 2, wherein determining that the current value of the target data affects the service logic of the pending transaction comprises determining, by the server, that the current value of the target data conflicts with the value of the target data.

4. The method of claim 2, further comprising rolling back, by the server, the pending transaction if the current value of the target data affects the service logic of the pending transaction.

5. The method of claim 1, further comprising:
executing, by the server, the pending transaction using the current value of the target data; and
updating, by the server, the current value of the target data in the target secondary database based on an execution result of the pending transaction.

6. The method of claim 5, further comprising:
acquiring, by the server, database operation instructions executed when performing a predictive execution on the pending transaction; and
wherein executing the pending transaction using the current value of the target data comprises: processing, by the server, the current value of the target data according to the database operation instructions; and obtaining, by the server, the execution result of the pending transaction based on processing the current value of the target data.

7. The method of claim 1, wherein acquiring predictive execution data associated with the pending transaction comprises receiving, by the server, the predictive execution data from a device performing a predictive execution on the pending transaction.

8. The method of claim 1 wherein receiving a pending transaction comprises intercepting, by the server, database operation instructions included within the pending transaction.

9. The method of claim 8 wherein the database operation instructions include a BEGIN TRANSACTION instruction.

10. An apparatus for optimizing database transactions, the apparatus comprising:
a processor; and
a non-transitory memory storing computer-executable instructions therein that, when executed by the processor, cause the apparatus to:
receiving a pending transaction;
acquiring predictive execution data associated with the pending transaction, wherein the predictive execution data includes a primary key value of target data required by the pending transaction and a value of the target data;
retrieving a current value of the target data from a target secondary database based on the primary key value of the target data;
determining whether the current value of the target data affects service logic of the pending transaction based on whether the current value of the target data is different from the value of the target data; and
recording in the target secondary database, the current value of the target data as version data corresponding to the pending transaction upon determining that the current value of the target data does not affect the service logic of the pending transaction.

11. The apparatus of claim 10 wherein the computer-executable instructions further cause the apparatus to prohibit the recording of the current value of the target data as version data corresponding to the pending transaction in the target secondary database upon determining that the current value of the target data affects the service logic of the pending transaction.

12. The apparatus of claim 11 wherein the instructions causing the apparatus to determine that the current value of the target data affects the service logic of the pending transaction further comprise instructions causing the apparatus to determine that the current value of the target data conflicts with the value of the target data.

13. The apparatus of claim 11 wherein the computer-executable instructions further cause the apparatus to roll back the pending transaction if the current value of the target data affects the service logic of the pending transaction.

14. The apparatus of claim 10 wherein the computer-executable instructions further cause the apparatus to:
execute the pending transaction using the current value of the target data; and
update the current value of the target data in the target secondary database based on an execution result of the pending transaction.

15. The apparatus of claim 14 wherein the computer-executable instructions further cause the apparatus to:
acquire database operation instructions executed when performing a predictive execution on the pending transaction; and
wherein the instructions causing the apparatus to execute the pending transaction using the current value of the target data further comprise instructions causing the apparatus to process the current value of the target data according to the database operation instructions and obtain the execution result of the pending transaction based on processing the current value of the target data.

16. The apparatus of claim 10 wherein the instructions causing the apparatus to acquire predictive execution data associated with the pending transaction further comprise instructions causing the apparatus to receive the predictive execution data from a device performing a predictive execution on the pending transaction.

17. The apparatus of claim 10 wherein the instructions causing the apparatus to receive a pending transaction further comprise instructions causing the apparatus to intercept database operation instructions included within the pending transaction.

18. The apparatus of claim 17 wherein the database operation instructions include a BEGIN TRANSACTION instruction.

19. A system for optimizing database transactions, the system comprising:
an application server;
one or more database servers; and
a database operation device configured to receive a pending transaction from the application server, the database operation device comprising:
an acquiring module configured to acquire predictive execution data associated with the pending transaction, wherein the predictive execution data includes a primary key value of target data required by the pending transaction and a value of the target data;
a loading module configured to retrieve a current value of the target data from a target secondary database, selected from the one or more database servers, based on the primary key value of the target data;
a determining module configured to determine whether the current value of the target data affects service logic of the pending transaction based on whether the current value of the target data is different from the value of the target data; and
a version data processing module configured to record in the target secondary database, the current value of the target data as version data corresponding to the pending transaction upon determining that the current value of the target data does not affect the service logic of the pending transaction.

20. The system of claim 19 wherein the database operation device further comprises:
a predictive execution module configured to perform a predictive execution on the pending transaction to generate the predictive execution data; and
a transaction execution module configured to acquire database operation instructions executed when performing a predictive execution on the pending transaction.
